(19) United States
(12) Patent Application Publication
(10) Pub. No.: US 2011/0246006 A1
(43) Pub. Date: Oct. 6, 2011

(54) METHOD AND APPARATUS FOR ELECTIC PROPULSION OF A VEHICLE USING A DUAL ENERGY STORAGE SYSTEM

(76) Inventors: Ching-Li Jimmy Wong, Bloomfield Hills, MI (US); Su-Chee Simon Wang, Troy, MI (US); William Chin-Woei Lin, Birmingham, MI (US)

(21) Appl. No.: 12/753,153

(22) Filed: Apr. 2, 2010

(51) Int. Cl. G06F 19/00

(52) U.S. Cl. 701/22; 180/65.275

(57) ABSTRACT

An electric propulsion system for a vehicle includes an electric motor operatively connected to a wheel of the vehicle. The system includes a first energy storage electrically connected to the electric motor to provide electric energy to the electric motor. The first energy storage is characterized by a first energy capacity and a first power capacity. The system includes a second energy storage characterized by a second energy capacity and a second power capacity. The second energy capacity is less than the first energy capacity and the second power capacity is greater than the first power capacity. The system includes a control module that detects a request of power for the vehicle and electrically connects the second energy storage to the electric motor to provide electric power based on the request.

### FIELD

The present invention relates to vehicle electric propulsion system, and more, particularly to the electric propulsion system with dual energy storage.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Vehicles may be propelled using electric propulsion systems. An electric propulsion system, may include an electric rotor with energy supplied by an energy storage system to provide electricity. The energy storage system may include one or more battery packs consisted of multiple battery cells to provide energy and power for vehicle operation. The battery packs may be hereinafter referred to as “battery”.

The battery contains a maximum energy capacity when it is fully charged. The maximum energy capacity may determine a range of vehicle operation using electric propulsion. During vehicle operation, power may be needed for vehicle acceleration or slope climbing. The battery may deliver electric power to meet the need up to a maximum power capacity of the battery.

Design specification an electrically propelled vehicle may require the battery pack to have a large energy capacity for driving the vehicle over a specified range. The specification may also require the battery pack to have a large power capacity for attaining a specified level of vehicle acceleration and slope climbing. However, for a battery pack to meet both requirements the battery weight and size may exceed allowable limitations, respectively.

### SUMMARY

In one feature, an electric propulsion system for a vehicle is described. The system includes an electric motor. The motor is operatively connected to a wheel of the vehicle. The system includes a first energy storage. The first energy storage is electrically connected to the electric motor to provide electric energy to the electric motor. The first energy storage is characterized by a first energy capacity and a first power capacity. The system also includes a second energy storage. The second energy storage is characterized by a second energy capacity and a second power capacity. The second energy capacity is less than the first energy capacity. The second power capacity is greater than the first power capacity. The system includes a control module that detects a request of power for the vehicle and electrically connects the second energy storage to the electric motor to provide electric power based on the request.

In other features, a method of operating an electric motor to propel a vehicle is described. The method includes detection of a main energy storage. The main energy storage can provide a first power less than or equal to a first power capacity. The method includes detection of an auxiliary energy storage. The auxiliary energy storage can provide a second power less than or equal to a second power capacity. The second power capacity is greater than the first power capacity. The method includes determination of a request of power of the vehicle. The method electrically connects the main energy storage to the electric motor when the request is less than or equal to a threshold. The method electrically connects the auxiliary energy storage to the electric motor when the request is greater than the threshold; and electrically disconnects the auxiliary energy storage from the electric motor when, the request is less than or equal to the threshold.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a plan view of an electric vehicle with a duel electric energy storage system according to the principle of the present invention;

FIG. 2 is a graph of battery energy discharge to illustrate battery characteristics;

FIG. 3 is a schematic diagram of a power switching module according to the principle of the present invention;

FIG. 4 is a graph illustrating a switch state based on power demand according to the principle of the present invention;

FIG. 5 is a schematic diagram of a power modulation module according to the principle of the present invention;

FIG. 6 is a schematic diagram of a main energy storage according to the principle of the present invention; and

FIG. 7 is a flow diagram depicting a method of operating a dual energy storage system according to the principle of the present invention.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable electrical or electronic components or devices that provide the described functionality.

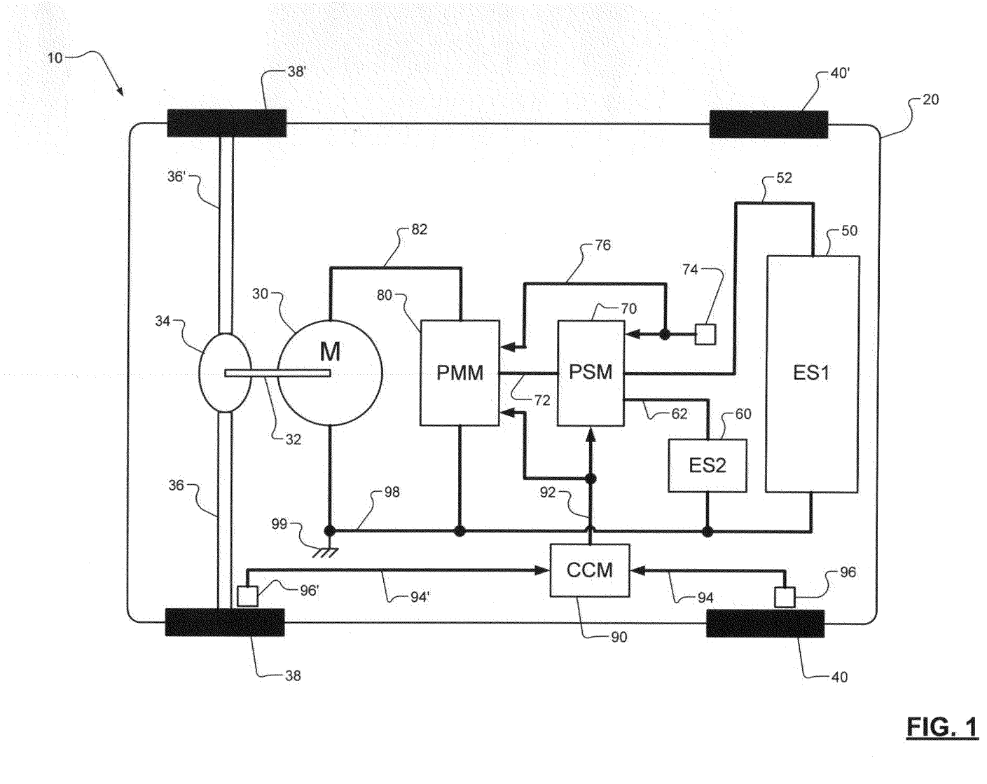

Referring now to FIG. 1, a plan view of an electric propulsion system 10 of an electric, vehicle 20 is shown. The vehicle 20 is propelled by an, electric motor 30. The electric motor 30 has an output shaft 32 operatively connected to a differential 34 of the vehicle 20. Torque from the electric motor 30 drives the vehicle 20 via the differential 34. The differential 34 is operatively connected to an axle member 36 that is connected to, and, drives a wheel 38′ at one side of the vehicle 20, and connected to another axle member 36′ that is connected to, and drives another wheel 38′ at another side of the vehicle 20 to propel the vehicle. The vehicle 20 may have wheels 40 and 40′ that are not driven by the electric motor 30 to propel the vehicle 20.

The vehicle 20 has a dual energy storage system that may include a main energy storage 50 and an auxiliary energy storage 60. The energy storage may include battery or batteries that store electric energy for propelling the vehicle 20. The main energy storage 50 may provide the electric energy via an electric conductor 52. The auxiliary energy storage 60 may provide the electric energy via an electric conductor 62. The electric conductors 52, 62 are electrically connected to a power switching module 70. The power switching module 70 may determine an auxiliary energy switching condition to apply the energy from the auxiliary energy storage 60 to propel the vehicle. The power switching module 70 may direct an electric current 72 from the energy storages 50, 60 to a power modulation module 80. The electric current 72 may be provided by the main energy storage 50 or the auxiliary energy storage 60, or the combination of both energy storages 50 and 60.

In one embodiment the main energy storage 50 may include an internal combustion engine. In another embodiment, the main energy storage 50 may include a fuel cell. Yet in the other embodiment, the auxiliary energy storage 60 may include a super capacitor.

The vehicle 20 may have an accelerator pedal sensor 74. The accelerator pedal sensor 74 may generate an accelerator pedal signal 76. The power switching module 70 may determine the auxiliary energy switching condition based on the accelerator pedal signal 76. The power modulation module 80 receives the electric current 72 and the accelerator pedal signal 76, and generates a modulated current 82 to drive the electric motor 30.

The vehicle 20 may have a chassis control module 90 and wheel speed sensors 96, 96′. The wheel speed sensors 96, 96′ may generate wheel speed signals 94 and 94′, respectively. The chassis control module 90 may receive the wheel speed signals 94, 94′. The chassis control module 90 may generate a chassis power request signal 92 based on the wheel speed signals 94 and 94′. The main energy storage 50, the auxiliary energy storage 60, the power modulation module 80 and the electric motor 30 may be electrically connected to a vehicle chassis ground 99 via an electrical grounding conductor 98.

In one embodiment, the power switching module 70 may determine the auxiliary energy switching condition based on the chassis power request signal 92. The power modulation module 80 may generate the modulated current 82 based on the chassis power request signal 92. For example, during an occasion where road surface is slippery and the driven wheel 38 experiences excessive wheel spin, the chassis power request signal 92 may indicate a lower level of power to be provided to the electric motor 30.

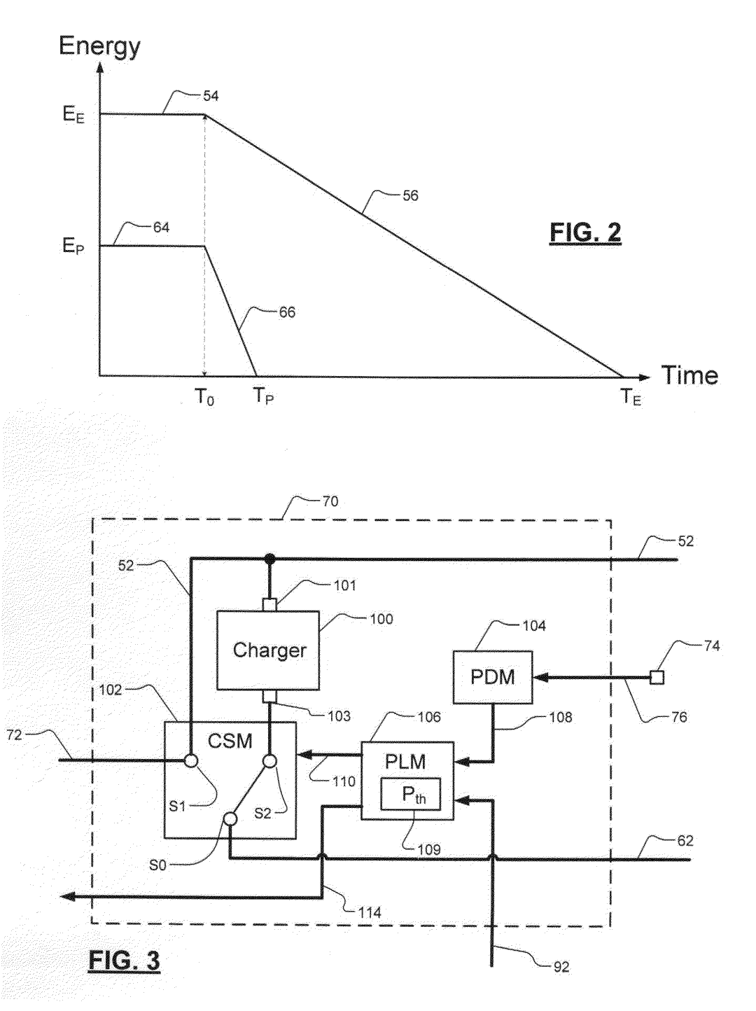

Referring now to FIG. 2, a graph illustrating battery discharge of two types of battery is shown. A battery may be characterized by an energy capacity and a power capacity. The energy capacity represents a maximum amount of energy the battery is capable of delivering from a fully charged state to a depleted state. The power capacity represents a maximum rate of power the battery is capable of delivering during a battery discharge operation. The maximum rate of power may also be derived from a maximum amount of electric current the battery can deliver during the battery discharge operation. A battery reaches its maximum rate of power when the discharge current is at half of its maximum current the battery is able to deliver. Further increase of the current may cause the power output to decline.

FIG. 2 shows a curve of energy level 54, 56 during battery discharge of a main battery that has an energy capacity of E_{E}. The main battery starts discharging at time T₀ and is depleted at time T_{E}. The main battery may be referred to as “energy battery”. FIG. 2 also shows a curve of energy level 64, 66 during battery discharge of an auxiliary battery that has an energy capacity of E_{P}. The auxiliary battery starts discharging at time T₀ and is depleted at time T_{P}. The auxiliary battery may be referred to as “power battery”. For illustrative purpose the energy battery has, a higher energy capacity E_{E} than the power battery that has an energy capacity of E_{P}.

Battery power may be represented by a rate of energy delivery, and the rate may be indicated by a slope of the battery energy curve during battery discharge. FIG. 2 illustrates a lower power capacity of the energy battery than the power battery. The power capacity of the energy battery may be indicated by the slope of the curve 56 during battery discharge, which is lower than the slope of the curve 66, of the power battery. In one embodiment, the power battery is smaller in size and lighter in weight than the energy battery.

Referring now also to FIG. 3, a schematic diagram of the power switching module 70 is shown. The power switching module 70 may include a charger module 100, a charging switch module 102, a power demand module 104 and a power logic module 106. The charger module 100 may include a charger input terminal 101. The electric conductor 52 may be electrically connected to the charger module 100 via the charger input terminal 101, and may be connected to the charging switching module 102 at a first switch point S1 of the charging switching module 102. The charger module 100 may include a charger output terminal 103 that is electrically connected to a second switching point S2 of the charging switching module 102.

The electrical conductor 62 is electrically connected to a base switching point S0 of the charging switching module 102. The charging switching module 102 may be electrically configured to connect the base switching point S0 with the first switching point S1 or the second switching point S2 based on a switch state signal 110. The switch state signal 110 may be a POWER or CHARGE. An example truth table of the switch state signal 110 and configuration of the charging switching module 102 is illustrated in Table 1.

TABLE 1

| Switch state | | |
|---|---|---|
| signal | Charging switching module configuration | |
| POWER | S0 and S1 connected | S0 and S2 disconnected |
| CHARGE | S0 and S1 disconnected | S0 and S2 connected |

The power demand module 104 receives the accelerator pedal signal 76 and generates an accelerator power request signal 108. The power logic module 106 receives the accelerator power request signal 108 and the chassis power request signal 92, and generates the switch state signal 110 based on a power threshold parameter Pₜₕ. The power threshold parameter Pₜₕ may be stored in memory 109. The power logic module 106 may include the memory 109.

The power logic module 106 may generate the switch state signal 110 based on the accelerator power request signal 108. The switch state signal 110 may be generated using a method 112 disclosed in FIG. 4. The power logic module 106 may also generate a motor power request signal 114 based on the accelerator power request signal 108 and the chassis power request signal 92.

The motor power request signal 114 may be generated based on the accelerator power request signal 108 or the chassis power request signal 92. In one embodiment, the motor power request signal may be generated based on a smaller one of the accelerator power request signal 108 and the chassis power request signal 92 when both power request signals 92, 108 are present. In another embodiment, the motor power request signal 114 may be determined based solely on the accelerator power request signal 108 when the chassis power request signal 92 is absent.

Referring now also to FIG. 4, the method 112 of generating the switch state is illustrated, the power logic module 106 may execute an algorithm to carry out the method 112. The method 112 includes comparing the motor power request signal 114 to the threshold parameter Pₜₕ stored in memory 109. The switch state is set to CHARGE when the motor power request signal 114 is less than the threshold parameter Pₜₕ. The switch state is set to POWER when the motor power request signal 114 is greater than or equal to the threshold parameter Pₜₕ.

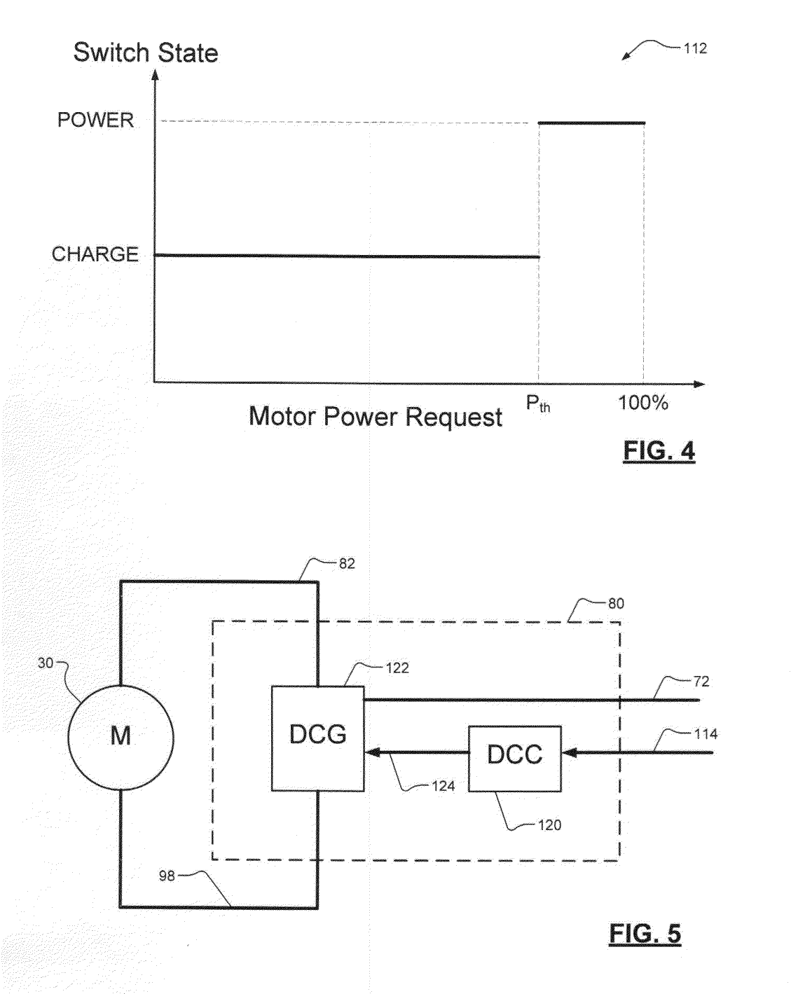

Referring now also to FIG. 5, a schematic diagram of the power modulation module 80 is shown. The power modulation module 80 may include a duty cycle controller 120 and a duty cycle generator 122. The duty cycle controller 120 may receive the motor power request signal 114 and generates a duty cycle signal 124 based on the motor power request signal 114.

The duty cycle generator 122 may receive the electric current 72 from the power switching module 70 and the duty cycle signal 124 from the duty cycle controller 120, and generate a modulated motor current 82 based on the electric current 72 and the duty cycle signal 124. The modulated motor current 82 is provided to the electric motor 30 to propel the vehicle 20. The duty cycle generator 122 may also be electrically connected to the electrical grounding conductor 98.

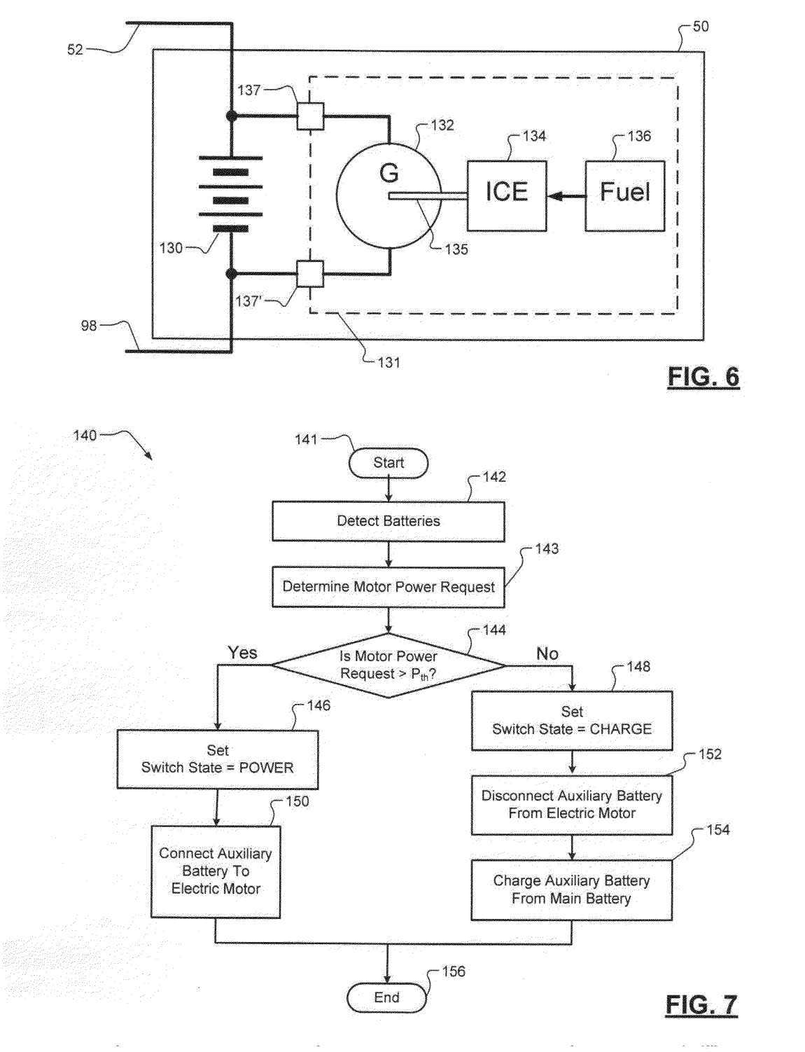

Referring now to FIG. 6, a schematic diagram of a main energy storage 50 is shown. The main energy storage 50 may include a battery pack 130 and an electricity generation system 131. The electricity generating system 131 may include an electric generator 132 that generates electricity to charge the battery pack 130, a internal combustion, engine 134 and a fuel storage 136 that provides fuel to operate the internal combustion engine 134.

In one embodiment, the electricity generating system 131 is hard wired to the battery pack 130 and fixed to the vehicle 20. In another embodiment, the electricity generating system 131 may be an assembly of engine and electric generator, and further includes one or more electric connectors 137, 137′. The electric generating system 131 may be connected to the battery pack 130 via the connectors 137, 137′, and may be disconnected from the battery pack 130 by separating the electrical contacts of the connectors 137, 137′. In this embodiment, the electric generator 132 and the internal combustion engine 134 are detachable from the vehicle 20.

Referring now also to FIG. 7, a method 140 of operating the electric propulsion system 10 is shown. Various modules of the power switching module 70 may perform relevant steps of the method 140. The method 140 may start at step 141.

In step 142, the power switching module 70 may detect the availability of operating energy storages to provide electric energy to the electric motor 30. The power switching module 70 may detect a main battery and an auxiliary battery. The power switching module 70 may recognize that the auxiliary battery can provide an electric power higher than that the main battery can provide. The power switching module 70 may also, recognize that the auxiliary battery can store a less amount of electric energy than the main battery can store.

In step 143, the power logic module 106 determines a motor power request and generates a motor power request signal 114 based on the motor power request. The motor power request may be determined based on an accelerator power request signal 108 and a chassis power request signal 92. The accelerator power request signal 108 may be generated based on an accelerator pedal signal 76 that is generated by an accelerator pedal sensor 74. The method 140 proceeds to step 144 after step 142.

In step 144, the power logic module 70 determines whether the motor power request has exceeded a predetermined threshold parameter Pₜₕ. The method 140 proceeds to step 146 when the motor power request exceeds the threshold parameter, otherwise the method 140 proceeds to step 148.

In step 146, the power logic module 106 sets the switch state to POWER, and proceeds to step 150 to configure the charging switch module 102 for the auxiliary battery to provide power to the electric motor. The method 140 proceeds to step 156 to end after step 150.

In step 148, the power logic module 106 sets the switch state to CHARGE, and proceeds to step 152 to configure the charging switch module 102 to disconnect the auxiliary battery from the electric motor. In step 154, the power logic module 106 configures the charging switch module 102 to charge the auxiliary battery from the main battery.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. An electric propulsion system for a vehicle comprising:
an electric motor operatively connected to a wheel of the vehicle;
a first energy storage electrically connected to the electric motor to provide electric energy to the electric motor, wherein the first energy storage is characterized by a first energy capacity and a first power capacity;
a second energy storage characterized by a second energy capacity and a second power capacity, wherein the second energy capacity is less than the first energy capacity and the second power capacity is greater than the first power capacity; and
a control module that:
determines a request of power for the electric motor, and
electrically connects the second energy storage to the electric motor to provide electric power based on the request.

2. The electric propulsion system in claim 1, wherein the first energy storage comprises a battery.

3. The electric propulsion system in claim 2, wherein the first energy storage further comprises an assembly of an internal combustion engine and an electric generator, wherein the internal combustion engine drives the electric generator to produce electricity.

4. The electric propulsion system in claim 3, wherein the electric generator includes an electric connector that can be attached to and detached from the vehicle.

5. The electric propulsion system in claim 1, wherein the first energy storage comprises a fuel cell.

6. The electric propulsion system in claim 1, wherein the second energy storage comprises a battery.

7. The electric propulsion system in claim 1, wherein the second energy storage comprises a super capacitor.

8. The electric propulsion system in claim 1 further comprising an electric charging device that is electrically interposed between the first energy storage and the second energy storage, wherein the charging device charges the second energy storage with electric energy provided by the first energy storage.

9. The electric propulsion system in claim 1, wherein the control module:
receives an accelerator pedal signal, and
determines the request based on the accelerator pedal signal.

10. The electric propulsion system in claim 1, wherein the control module:
receives a chassis control signal, and
detects the request based on the chassis control signal.

11. A method of operating an electric motor to propel a vehicle comprising:
detecting a main energy storage that can provide a first power less than or equal to a first power capacity;
detecting an auxiliary energy storage that can provide a second power less than or equal to a second power capacity, wherein the second power capacity is greater than the first power capacity;
determining a request of power of the vehicle;
electrically connecting the main energy storage to the electric motor when the request is less than or equal to a threshold;
electrically connecting the auxiliary energy storage to the electric motor when the request is greater than the threshold; and
electrically disconnecting the auxiliary energy storage from the electric motor when the request is less than or equal to the threshold.

12. The method of claim 11 further comprising charging the auxiliary energy storage when the request is less than the threshold.

13. The method of claim 12 further comprising charging the auxiliary energy storage using the energy stored in the main energy storage when the request is less than the threshold.

14. The method of claim 11 further comprising electrically connecting the main energy storage to the electric motor when the request is greater than the threshold.
